(19) United States
(12) Patent Application Publication
(10) Pub. No.: US 2026/0242598 A1
(43) Pub. Date: Aug. 20, 2026

(54) COMPOSITE MADE OF RANDOMLY BONDED POLYMER FIBER LOOPS AND POLYURETHANE FOAM

(71) Applicant: Dow Global Technologies LLC, Midland, MI (US)

(72) Inventors: Zheng Zhang, Shanghai (CN); Degang Zhang, Shanghai (CN); Ming Ming, Shanghai (CN); Xilun Weng, Shanghai (CN); Zhe Du, Shanghai (CN); Libo Du, Shanghai (CN)

(21) Appl. No.: 19/469,401

(22) PCT Filed: Sep. 28, 2023
(86) PCT No.: PCT/CN2023/122488

§ 371 Date: Sep. 26, 2025

(51) Int. Cl. C08L 75/08; B29C 44/12; B29K 75/00; B29K 223/00; B29K 623/00; C08J 5/04; C08K 11/00

(52) U.S. Cl. CPC C08L 75/08; B29C 44/1276; C08J 5/04; C08K 11/00; B29K 2075/00; B29K 2223/00; B29K 2623/00; C08J 2375/04; C08J 2423/02

(57) ABSTRACT

Provided is a composite comprising, a polyurethane foam, and a three-dimensional loop (3DL) preform comprising a plurality of randomly bonded thermoplastic fiber loops, wherein the 3DL preform is asymmetrically embedded in the polyurethane foam, with the voids of the fiber loops partially or completely filled with the polyurethane foam, and wherein the composite has an SAG factor of no less than 3.2, wherein the SAG factor is defined as the ratio of 65% Indentation Force Deflection (IFD) to 25% IFD. Also provided are method of preparing and use of the same.

### FIELD OF THE DISCLOSURE

The present disclosure is related to a composite, and specifically a composite comprising a three dimensional looped (3DL) preform and polyurethane foam. The composite makes it possible to provide thin cushions with desired comfort properties.

### BACKGROUND

Polyurethane foam is a widely used cushion material in car seats. The soft surface provides good touch feeling and vibration reduction, and strong compression resistance to provide enough support to the human body. It is a market trend in car seat design to develop thinner cushions to provide more space for drivers and passengers. However, for such thinner cushion design with normal firmness, the support from conventional polyurethane foam is not enough, and the users can feel the bottom when sitting on the seat; but when high-firm foam is used, the surface softness is affected and the users may feel uncomfortable. It is quite challenging to develop a thin polyurethane foam cushion to balance surface softness and efficient support to the users.

Thus, there remains a need for materials that make space-saving cushions with desired comfort features possible.

### SUMMARY OF THE DISCLOSURE

In an aspect, the present disclosure provides a composite comprising,
a polyurethane foam, and
a three-dimensional loop (3DL) preform comprising a plurality of randomly bonded thermoplastic fiber loops,
wherein the 3DL preform is asymmetrically embedded in the polyurethane foam, with the voids of the fiber loops partially or completely filled with the polyurethane foam, and
wherein the composite has an SAG factor of no less than 3.2, wherein the SAG factor is defined as the ratio of 65% Indentation Force Deflection (IFD) to 25% IFD.

In a further aspect, the present disclosure provides a method of preparing the composite described herein, comprising,
disposing, in a mold, a 3DL preform comprising a plurality of randomly bonded thermoplastic fiber loops;
injecting a reaction mixture into the mold and foaming in-situ, so that the 3DL preform is asymmetrically embedded in the polyurethane foam with the voids of the fiber loops partially or completely filled with the polyurethane foam;
solidifying the foam; and
releasing the composite from the mold.

In a further aspect, the present disclosure provides a product comprising the composite described herein.

It is to be understood that both the foregoing general description and the following detailed description are exemplary and explanatory only and are not restrictive of the invention, as claimed.

### BRIEF DESCRIPTION OF THE DRAWINGS

FIGS. 1A and 1B each schematically illustrate an embodiment of the composite according to the present disclosure.

FIG. 2 schematically illustrates the PU foam/3DL composite for the inventive samples.

### DETAILED DESCRIPTION OF THE DISCLOSURE

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

As disclosed herein, all percentages mentioned herein are by weight, and temperatures in ° C., unless specified otherwise.

The terms “comprising,” “including,” “having,” and their derivatives, as used herein, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

### I. Composite

In an aspect, provided is a composite, comprising,
a polyurethane foam, and
a 3DL preform comprising a plurality of randomly bonded thermoplastic fiber loops.

The 3DL preform is asymmetrically embedded in the polyurethane foam, with the voids of the fiber loops partially or completely filled with the polyurethane foam.

As used herein, “asymmetrically embedded” or “asymmetrically positioned” means that the 3DL preform is not centrally embedded or positioned within the polyurethane foam, and the composite has an asymmetric structure. Generally, the 3DL preform is embedded or positioned in the polyurethane foam so that it is further away from the intended force-bearing surface of the composite than from the opposite surface (that is, the surface opposite the intended force-bearing surface) of the composite. In other words, the depth from the intended force-bearing surface of the composite to the preform is greater than the depth from the opposite surface to the preform. In some embodiments, the preform is closer to or more adjacent to the opposite surface of the composite than to the intended force-bearing surface of the composite. In some embodiments, the center of gravity of the composite is not located at its geometric center.

As used herein, the “intended force-bearing surface” of the composite refers to a surface of the composite that is expected to be used to withstand a force (for example pressure, such as that caused by body weight).

In some embodiments, the force can be a force of sitting down or leaning on the composite.

In some embodiments, the opposite surface can have a similar shape and/or area to the intended force-bearing surface of the composite.

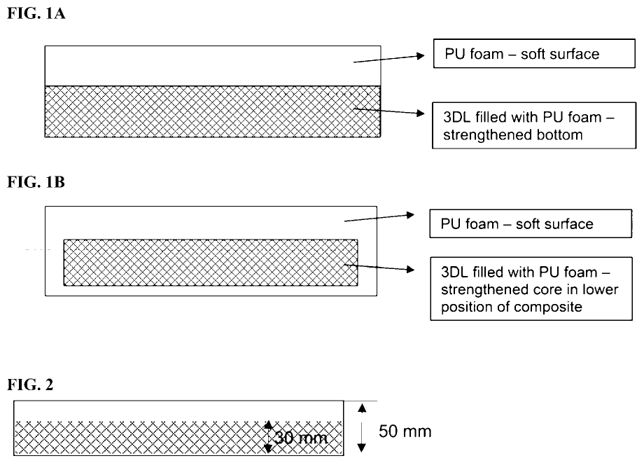

In the embodiments where the intended force-bearing surface is the top, the 3DL preform is embedded or positioned at the lower part (illustratively shown in FIG. 1A) or bottom (illustratively shown in FIG. 1B) of the composite, and vice versa.

The 3DL preform can be in a form or shape that is designed to take the force of for example sitting down or leaning on. In some embodiments, the 3DL preform can be in the form of a layer that is partially or completely parallel to the intended force-bearing surface and/or the opposite surface of the composite.

As used herein, “partially filled” means that at least 50% of the voids of the fiber loops of the 3DL preform are filled, for example, with the polyurethane foam. In some embodiments, at least 50%, at least 55%, at least 60%, at least 65%, at least 70%, at least 75%, at least 80%, at least 85%, at least 90%, at least 95%, at least 98% or 100% of the voids of the fiber loops are filled.

In some embodiments, the thickness of the polyurethane foam is larger than the 3DL preform. In some embodiments, the thickness of the polyurethane foam is 1.5 to 2.5 times the thickness of the 3DL preform, for example, 1.5, 1.6, 1.7, 1.8, 1.9, 2.0, 2.1, 2.2, 2.3, 2.4, 2.5 times the thickness of the 3DL preform. To provide a soft feel, the composite comprises a pure polyurethane foam portion extending from the intended force-bearing surface of the composite to a depth that is at least 10% (for example, at least 10%, at least 15%, at least 20% or at least 25%) of the total thickness of the composite. The total thickness of the composite is typically the distance between the intended force-bearing surface and the opposite surface of the composite.

In some embodiments, the 3DL preform is partially or completely embedded in the polyurethane foam. As used herein, “partially embedded” means that at least 70% of the volume of the 3DL preform is embedded in the polyurethane foam. In some embodiments, at least 70%, at least 75%, at least 80%, at least 85%, at least 90%, at least 95%, at least 98% or 100% of the volume of the 3DL preform is embedded in the polyurethane foam. In some embodiments, the 3DL preform is completely embedded in the composite.

The composite can be designed to have a desired shape (e.g., ergonomic seat or back cushion shape). In some embodiments, the composite can be designed to be wrapped in layer(s) of leather, fabric, or polymer (e.g., cushion covers), to be held in position. In some embodiments, the composite can further comprise one or more jointing elements extending beyond the composite to secure the composite in position.

It has been found that by providing the asymmetric composite where the upper or top portion is polyurethane foam for vibration reduction and good touch feel and the lower or bottom portion is strengthened with 3DL to provide strong compression resistance and body weight support, thinner cushions or seat padding materials can be obtained. It saves more space without compromising the desired cushion comfort properties.

SAG factor, defined as the ratio of Indentation Force Deflection at 65% to the indentation force deflection at 25% (IFD 65% to IFD 25%), is used as an indicator of cushioning quality in foam industry. The IFD values can be measured in accordance with the standard ASTM D3574-2017.

Generally, SAG values for polyurethane foam are in a range of 2.0 to 3.0. A high SAG value indicates a resistance to “bottoming out”, and a foam product with SAG factor greater than 2.8 is already recognized as high support factor foam and not easy to achieve. The composite according to the present disclosure achieves an SAG factor of >3.2, representing great support and comfort to the users. In some embodiments, the composite can have an SAG factor of no less than 3.2, for example, no less than 3.3, 3.4, 3.5, 3.6, 3.7, 3.8. 3.9, or 4.0.

In some embodiments, the compression residual strain of the composite measured in accordance with ASTM D3574-2017 (D) is ≤20%, for example, ≤15%, ≤12%, or ≤10%.

In some embodiments, the thickness change after fatigue of the composite measured in accordance with ASTM D 3574-2017 (I₃) is ≤5%, for example, ≤2.5%, ≤1.5%, or ≤1%.

In some embodiments, the firmness change after fatigue of the composite measured in accordance with ASTM D 3574-2017 (I₃) is ≤25%, for example, ≤20%, ≤18%, or ≤16%.

In some embodiments, the composite has a rebound of >40%, for example, ≥42%, ≥43% or ≥45%, as measured in accordance with ASTM D3574-2017.

In some embodiments, the composite has a hysteresis loss of ≤40%, for example, ≤38%, ≤37% or ≤35%, as measured in accordance with ASTM D3574-2017.

### I. Polyurethane Foam

The foam comprised in the composite according to the present disclosure is made of polyurethane.

The polyurethane foam is a reaction product of a reaction mixture comprising (i) a polyol component comprising one or more polyols selected from the group consisting of a polyester polyol, a polyether polyol, and the combination thereof, and (ii) an isocyanate component comprising one or more isocyanate compounds.

The polyol component and the isocyanate component are separated from each other before use. Typically, the polyol component and the isocyanate component can be prepared, stored, transported and served separately, and combined shortly or immediately before being applied to, for example, a mold for producing the composite. It is contemplated that when these two components are brought into contact, a curing reaction begins in which the polyol groups react with the isocyanate groups to form urethane links. The reactive polyurethane dispersion formed by bringing the two components into contact can be referred to as a “reaction mixture” or a “curable mixture.”

The NCO/OH molar ratio of the isocyanate component to the polyol component comprised in the polyurethane foam composition can be within the range of from 0.5:1 to 1.2:1. As used herein, the term “NCO/OH molar ratio” refers to the ratio of the number of isocyanate groups to the number of hydroxyl groups in the reaction mixture; or more specifically, the ratio between the number of isocyanate groups in the isocyanate component and the number of hydroxyl groups in the polyol component of the reaction mixture. In some embodiments, NCO/OH molar ratio of the isocyanate component to the polyol component can be within the range obtained by combining any two of the following endpoints: 0.5:1, 0.6:1, 0.7:1, 0.8:1, 0.9:1, 1:1, 1.1:1, 1.2:1. In some specific embodiments, the NCO/OH molar ratio of the isocyanate component to the polyol component can be within the range of from 0.5:1 to 1.2:1, from 0.6:1 to 1.1:1, from 0.7:1 to 1:1, from 0.8:1 to 1.2:1, from 0.9:1 to 1.1:1, from 0.9:1 to 1:1 or from 1:1 to 1:1.1.

In some embodiments, the polyurethane foam has a density of from 15 to 150 kg/m³.

### (i) Polyol Component

The polyol component can comprise one or more polyols selected from the group consisting of polyester polyols, polyether polyols, and any combination thereof.

As used herein, the term “polyol” refers to a compound with two or more hydroxyl groups. A polyol is a “diol” when it has exactly two hydroxyl groups, a “triol” when it has exactly three hydroxyl groups, a “tetraol” when it has exactly four hydroxyl groups, a “pentanol” when it has exactly five hydroxyl groups, and so on.

The one or more polyols in the polyol component can have an average hydroxyl group functionality of from 2 to 8. In some embodiments, the one or more polyols have an average hydroxyl group functionality of from 2 to 8, 2 to 7, 2 to 6, or 3 to 6.

The one or more polyols in the polyol component can have an average hydroxyl group number from 19 to 1000 mg KOH/g, for example, from 19 to 800 mg KOH/g, from 19 to 500 mg KOH/g, or from 19 to 200 mg KOH/g.

The one or more polyols in the polyol component can have a molecular weight not to exceed 14,000 g/mol, 12,000 g/mol, or 10,000 g/mol.

In some embodiments, the polyol component can have a viscosity at 25° C. of from 200 cSt to 38,000 cSt, for example, from 200 cSt to 35,000 cSt, or from 250 cSt to 35,000 cSt, as measured according to ASTM D2196.

In some embodiments the polyol component can comprise one or more polyether polyols.

A compound that contains two or more ether linkages in the same linear chain of atoms is known herein as a “polyether.” A compound that is a polyether and a polyol is a “polyether polyol.”

In some embodiments, the polyether polyols can be obtained by the addition polymerisation of alkylene oxides with polyhydric alcohol starter compounds. Examples of such polyhydric alcohols can comprise, but are not limited to, glycerin, sorbitol, sucrose, glucose, fructose, lactose or other sugars. In some embodiments, the starter compound is sorbitol or sucrose. These polyhydric alcohols as well as mixtures of these alcohols with water, glycerol, propylene glycol, ethylene glycol or diethylene glycol, may be used as starter compounds. In some embodiments, the polyether polyols can comprise a styrene acrylonitrile (SAN) based copolymer polyether polyol which is a graft polyol.

Examples of suitable polyether polyols that can be used can comprise, but are not limited to, VORANOL™ 446, VORANOL™ 520, VORANOL™ 550, VORANOL™ RN 482, VORANOL™ CP 6001, VORANOL™ CP 4711, VORALUX™ HL 400, SPECFLEX™ NC 702 polyols, all available from The Dow Chemical Company.

In some embodiments, the polyol component can comprise one or more polyester polyols.

A compound that contains two or more ester linkages in the same linear chain of atoms is known herein as a “polyester.” A compound that is both a polyester and a polyol is known herein as a “polyester polyol.”

In some embodiments, the polyester polyols can comprise, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or lactones. The polyester polyols can also be derived from, instead of the free polycarboxylic acids, the corresponding polycarboxylic anhydrides, or corresponding polycarboxylic esters of lower alcohols.

Suitable diols can comprise, but are not limited to, ethylene glycol, butylene glycol, diethylene glycol, triethylene glycol, pentylene glycol, hexalene glycol, polyalkylene glycols, such as polyethylene glycol, and also 1,2-propanediol, 1,3-propanediol, 1,3-butanediol, 1,4-butanediol, 1, 6-hexanediol, and neopentyl glycol. If a polyester polyol functionality greater than 2 is to be achieved, polyols having a functionality of 3 or greater can optionally be comprised in the polyol composition (e.g., trimethylolpropane, glycerol, erythritol, pentaerythritol, trimethylolbenzene or trishydroxyethyl isocyanurate).

Suitable dicarboxylic acids can comprise, but are not limited to, aliphatic acids, aromatic acids, and combinations thereof. Examples of suitable aromatic acids can comprise, but are not limited to, phthalic acid, isophthalic acid, terephthalic acid, and tetrahydrophthalic acid. Examples of suitable aliphatic acids can comprise, but are not limited to, hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, 2,2-dimethyl succinic acid, and trimellitic acid. As used herein, the term “acid” also comprises any anhydrides of said acid. Further, monocarboxylic acids, such as benzoic acid and hexane carboxylic acid, should be minimized or excluded from the disclosed compositions. Saturated aliphatic and/or aromatic acids are also suitable for use according to this disclosure, such as adipic acid or isophthalic acid.

### (ii) Isocyanate Component

The isocyanate component can comprise one or more isocyanate compounds reactive with the one or more polyols in the polyol component.

In some embodiments, the isocyanate compound can be one or more selected from isocyanate monomers, isocyanate prepolymers, modified isocyanates and combination thereof.

As used herein, an “isocyanate monomer” is any compound that contains two or more isocyanate groups. An “aromatic isocyanate” is an isocyanate that contains one or more aromatic rings. An “aliphatic isocyanate” contains no aromatic rings. In some embodiments, the isocyanate compound comprises an aromatic isocyanate.

Isocyanate monomers suitable for use according to the disclosure can be selected from the group consisting of aromatic isocyanates, aliphatic isocyanates, carbodiimide modified isocyanates, and the combinations thereof. Examples of aromatic isocyanates suitable for use according to the disclosure can comprise, but are not limited to, isomers of methylene diphenyl dipolyisocyanate (“MDI”) such as 4,4-MDI, 2,4-MDI and 2,2′-MDI, or modified MDI such as carbodiimide modified MDI or urethane modified MDI or allophanate modified MDI; isomers of toluene-dipolyisocyanate (“TDI”) such as 2,4-TDI, 2,6-TDI, isomers of naphthalene-dipolyisocyanate (“NDI”) such as 1,5-NDI, and the combinations thereof. Examples of aliphatic isocyanates suitable for use according to this disclosure can comprise, but are not limited to, isomers of hexamethylene dipolyisocyanate (“HDI”), isomers of isophorone dipolyisocyanate (“IPDI”), isomers of xylene dipolyisocyanate (“XDI”), isomers of methylene-bis-(4-cyclohexylisocyanate) (“HMDI”), and the combinations thereof. In some embodiments, the isocyanate monomers comprises diisocyanate monomers selected from the group consisting of isophorone diisocyanate (IPDI), methylene-bis-(4-cyclohexylisocyanate) (HMDI), hexamethylene diisocyanate (HDI), methylene diphenyl diisocyanate (MDI), toluene diisocyanate (TDI), and the combination thereof.

In some embodiments, the isocyanate component of the reaction mixture can be prepared using any organic polyisocyanates, modified polyisocyanates, isocyanate based prepolymers, and mixtures thereof. These can comprise aliphatic and cycloaliphatic isocyanates, but aromatic and especially multifunctional aromatic isocyanates such as 2,4- and 2,6-toluenediisocyanate and the corresponding isomeric mixtures; 4,4′-, 2,4′- and 2,2′-diphenyl-methanediisocyanate (MDI) and the corresponding isomeric mixtures; mixtures of 4,4′-, 2,4′- and 2,2′-diphenylmethanediisocyanates and polyphenyl polymethylene polyisocyanates (PMDI). In some embodiments, mixtures of PMDI and toluene diisocyanates are comprised. In some embodiments, the polyisocyanate used to prepare the prepolymer formulation of the present invention is MDI or PMDI or crude mixtures of any of these.

In some embodiments, the isocyanate component can have a viscosity at 25° C. of from 50 mPa-s to 20,000 mPa-s, from 50 mPa-s to 18,000 mPa-s, or from 100 mPa-s to 18,000 mPa-s, as measured according to ASTM D2196.

(iii) Further Components

In some embodiments, the reaction mixture further comprises one or more catalysts, including amine compounds (for example, tertiary amine compounds), organometallic compounds, and any combination thereof. Exemplary tertiary amine compounds can comprise, but are not limited to, triethylenediamine, N-methylmorpholine, N,N-dimethylcyclohexylamine, N,N′,N′-dimethylaminopropylhexahydrotriazine, 2-hydroxy-N,N,N-trimethylpropan-1-aminium formate, pentamethyldiethylenetriamine, tetramethylethylenediamine, 1-methyl-4-dimethylaminoethylpiperazine, 3-methoxy-N-dimethylpropylamine, N-ethylmorpholine, diethylethanolamine, N-cocomorpholine, N,N-dimethyl-N′,N′-dimethyl isopropylpropylenediamine, N,N-diethyl-3-diethylaminopropylamine and dimethylbenzylamine. Exemplary organometallic catalysts can comprise, but are not limited to, organomercury, organolead, organoferric and organotin catalysts. Suitable tin catalysts can comprise, but are not limited to, stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. Such catalysts are used in an amount which measurably increases the rate of polyurethane formation. The one or more catalysts can be comprised in either or both of the polyol component and the isocyanate component. Typical amounts are 0.001 to 3 parts by weight of catalyst per 100 parts by weight the polyol component. In some embodiments, the reaction mixture comprises amine catalysts, tin catalysts, or a mixture thereof. The catalyst(s) can be present in the polyol component. The catalyst(s) can be present in an amount of 0.25% to 5% by weight of the polyol component.

In some embodiments, the reaction mixture further comprises one or more blowing agents. The blowing agent used in the reaction mixture can comprise at least one physical blowing agent which is selected from a hydrocarbon, hydrofluorocarbon, hydrochlorofluorocarbon, fluorocarbon, dialkyl ether or fluorine-substituted dialkyl ether, or any combination thereof. Blowing agents of these types can comprise, but are not limited to, propane, isopentane, n-pentane, n-butane, isobutane, isobutene, cyclo-pentane, dimethyl ether, 1,1-dichloro-1-fluoroethane (HCFC-141b), chlorodifluoromethane (HCFC-22), 1-chloro-1,1-difluoroethane (HCFC-142b), 1,1,1,2-tetrafluoroethane (HFC-134a), 1,1,1,3,3-pentafluorobutane (HFC-365mfc), 1,1-difluoroethane (HFC-152a), 1,1,1,2,3,3,3-heptafluoropropane (HFC-227ea), 1,1,1,3,3-pentafluoropropane (HFC-245fa), hydrofluoroolefin (HCFO), hydrofluoroolefin (HFO) such as LBA, and any combination thereof. The reaction mixture can comprise a chemical blowing agent, such as water, carboxylic acid, formic acid, and any combination thereof. The one or more blowing agents can be comprised in either or both of the polyol component and the isocyanate component. In some embodiments, the one or more blowing agents are comprised in the polyol component. Typically, the blowing agent constitutes from 1 to 20 parts by weight per 100 parts by weight the polyol component. The blowing agent(s) can be present in the polyol component. The blowing agent(s) can be present in an amount of 1% to 5% by weight of the polyol component.

In some embodiments, the reaction mixture further comprises one or more foam-stabilizing surfactants. The foam-stabilizing surfactant helps stabilize gas bubbles formed during the foaming process until the polymer has cured. A wide variety of silicone surfactants as are commonly used in making polyurethane foams can be used in making composites of the disclosure. Surfactants that are self-dispersible or soluble in water are preferred. Examples of such silicone surfactants are commercially available under the trade names Tegostab™, Niax™ and Dabco™. Other useful surfactants include block copolymers of ethylene oxide and propylene oxide and/or butylene oxide wherein the poly(ethylene oxide) block or blocks constitute 35 to 75% of the total weight of the block copolymer. Such block copolymers may have one or more hydroxyl groups. The surfactant(s) may be present in the polyol component. The surfactant(s) can be in an amount of 0.25% to 5% by weight of the polyol component.

Optionally, the reaction mixture further comprises one or more chain extension and or cross linkage agents. Examples of such agents can comprise, but are not limited to, ethylene glycol, diethylene glycol, triethylene glycol, propylene oxide, propylene glycol, dipropylene glycol, tripropylene glycol, 1,4-butane diol, 1,6-hexane diol, 1,8-octane diol, cyclohexane dimethanol, glycerin, trimethylolpropane, trimethylolethane, pentaerythritol, sorbitol and sucrose, as well as alkoxylates, diethanol amine, monoethanol amine, triethanol amine, mono-, di- or tri(isopropanol) amine, glycerine, trimethylol propane, and combinations thereof. Such agent(s) can be present in the polyol component, for example in an amount of 0.25 to 5% by weight of the polyol component.

Optionally, the reaction mixture further comprises one or more additives such as anti-oxidants, preservatives, pigments, colorants, and flame retardant additives.

### III. Three-Dimensional Loop (3DL) Preform

The composite according to the present disclosure comprises a 3DL preform comprising a plurality of randomly bonded thermoplastic fiber loops.

In some embodiments, the fiber loops are randomly formed by allowing continuous fibers to bend to come in contact with one another in a molten state and be heat-bonded at a plurality of contact points.

The vast majority (greater than 50%) of the fibers comprised in the 3DL preform are made of a polyolefin, preferably a polyolefin elastomer.

In some embodiments, the polyolefin elastomer can be selected from the group consisting of ethylene-propylene copolymers (such as ethylene propylene rubber (EPM) and ethylene propylene diene rubber (EPDM)), ethylene/alpha-olefin copolymers (such as ethylene/alpha-olefin random copolymer (POE) and ethylene/alpha-olefin block copolymer (OBC)), and a combination thereof.

In some embodiments, the polyolefin elastomer has a density of 0.88 to 0.92 g/cm³.

An “alpha-olefin” or “α-olefin” generally is a C₃₋₂₀ linear, branched or cyclic hydrocarbon molecule comprising an ethylenic unsaturation between the first and second carbon atoms.

A “polyolefin” or “PO” is a polymer that contains more than 50 mole percent polymerized olefin monomer (based on total amount of polymerizable monomers), and optionally, may contain one or more comonomer(s). Nonlimiting examples of olefin-based polymer include ethylene-based polymer and propylene-based polymer.

An “ethylene/alpha-olefin interpolymer” is an interpolymer that comprises a majority amount (i.e., over 50 mole percent) of polymerized ethylene monomer (based on the total amount of polymerizable monomers) and one or more alpha-olefin comonomers.

In some embodiments, the 3DL preform comprises at least one ethylene/alpha-olefin copolymer. In some embodiments, the ethylene/alpha-olefin copolymer is a random ethylene/alpha-olefin interpolymer or a block ethylene/alpha-olefin interpolymer.

The ethylene/alpha-olefin copolymer comprises ethylene as a major monomer. In some embodiments, the ethylene/alpha-olefin copolymer comprises at least 60%, for example, at least 65%, at least 70%, at least 75% or at least 80% by weight of the copolymer of ethylene as the major monomer. In some embodiments, the amount of ethylene comprised in the ethylene/alpha-olefin copolymer is within the range formed by taking any two of the numerical values in the following list as the endpoints: 60%, 65%, 70%, 75%, 80%, 85% and 90%, by weight of the copolymer. In some embodiments, the ethylene/alpha-olefin copolymer comprises from 60% to 90%, from 65% to 90%, from 70% to 90% or from 75% to 90% by weight of the copolymer of ethylene.

The ethylene/alpha-olefin copolymer comprises at least one alpha-olefin as a comonomer. Typically, the at least one alpha-olefin comprised in the ethylene/alpha-olefin copolymer of the present disclosure has four or more carbon atoms. In some embodiments, the ethylene/alpha-olefin copolymer comprises one or more C₄₋₁₀ alpha-olefins as comonomers. In some exemplary embodiments, the C₄₋₁₀ alpha-olefin can be selected from the group consisting of 1-butene, 1-pentene, 1-hexene, 1-heptene, 1-octene, 1-nonene, 1-decene, and combinations thereof. In some embodiments, the C₄₋₁₀ alpha-olefin comprises 1-octene. In some exemplary embodiments, the ethylene/alpha-olefin copolymer can be selected from the group consisting of ethylene/1-hexene copolymer, ethylene/1-heptene copolymer, ethylene/1-octene copolymer, ethylene/1-nonene copolymer, ethylene/1-decene copolymer, and combinations thereof. In some embodiments, the ethylene/alpha-olefin copolymer comprises ethylene/1-octene copolymer.

In some embodiments, the ethylene/alpha-olefin copolymer comprises at most 40%, for example, at most 35%, at most 30%, at most 25%, at most 20%, at most 15% or at most 10% by weight of the copolymer of a C₄₋₁₀ alpha-olefin as comonomer. In some embodiments, the amount of the C₄₋₁₀ alpha-olefin comprised in the ethylene/alpha-olefin copolymer is within the range formed by taking any two of the numerical values in the following list as the endpoints: 40%, 35%, 30%, 25%, 20%, 15%, and 10%, by weight of the copolymer. In some embodiments, the ethylene/alpha-olefin copolymer comprises from 40% to 10%, from 35% to 10%, from 30% to 10% or from 25% to 10% by weight of the copolymer of a C₄₋₁₀ alpha-olefin.

Examples of the polyolefins that can be used in the 3DL preform can include those commercially available from The Dow Chemical Company, under the trade name ELITE™, ENGAGE™, VERSIFY™, and INFUSE™.

In some embodiments, based on the total weight of the fibers comprised in the 3DL preform, more than 50%, more than 50%, more than 55%, more than 60%, more than 65%, more than 70%, more than 75%, more than 80%, more than 85%, more than 90%, more than 95%, or 100% of the fibers are made of polyolefin elastomers.

In some embodiments, based on the total weight of the fibers comprised in the 3DL preform, less than 10%, less than 5%, less than 2%, less than 1%, less than 0.5% or less than 0.10% of the fibers are made from other materials, for example, aramid fibers, polyester fibers, cellulose fibers (e.g., regenerated cellulose fibers).

In some embodiments, the fibers comprised in the 3DL preform have a diameter that is no less than about 0.3 mm. In some embodiments, the fibers comprised in the 3DL preform have a diameter that is no more than about 2.0 mm. In some embodiments, the fibers comprised in the 3DL preform have a diameter that is within the range formed by taking any two of the numerical values in the following list as the endpoints: 0.3, 0.4, 0.5, 0.6, 0.8, 1.0, 1.2, 1.4, 1.6, 1.8, 1.9, and 2.0 mm. In some embodiments, the fibers comprised in the 3DL preform have a diameter that is within the range from about 0.3 mm to about 2.0 mm, from about 0.5 mm to about 2.0 mm, from about 0.3 mm to about 1.5 mm, or from about 0.5 mm to about 1.2 mm.

In some embodiments, the 3DL preform has a density that is no less than about 20 kg/m³. In some embodiments, the 3DL preform has a density that is no more than about 100 kg/m³. In some embodiments, the 3DL preform has a density that is within the range formed by taking any two of the numerical values in the following list as the endpoints: 20, 30, 40, 50, 60, 70, 80, 90 and 100 kg/m³. In some embodiments, the 3DL preform has a density that is within the range from about 20 kg/m³ to about 100 kg/m³, from about 20 kg/m³ to about 80 kg/m³, from about 20 kg/m³ to about 70 kg/m³, or from about 30 kg/m³ to about 60 kg/m³.

In some embodiments, the polyolefin(s) (e.g., polyolefin elastomer(s)) comprised in the 3DL preform have a melting index (MI) in a range of 1 to 35 g/10 min @190° C., 2.16 kg, for example, 1 to 30, or 1 to 20 g/10 min @190° C., 2.16 kg, as measured in accordance with ASTM D1238.

In some embodiments, the 3DL preform is a nonwoven material.

In some embodiments, the 3DL preform can further comprise one or more additives or agents such as antioxidants, pigments, flame retardants, and the like.

### VI. Production of Composite

The present disclosure also provides a method of producing the composite described herein. In an exemplary embodiment, the method comprises,
disposing, in a mold, a 3DL preform comprising a plurality of randomly bonded thermoplastic fiber loops;
injecting a reaction mixture into the mold and foaming in-situ, so that the 3DL preform is asymmetrically embedded in the polyurethane foam with the voids of the fiber loops partially or completely filled with the polyurethane foam;
solidifying the foam; and
releasing the composite from the mold.

### V. Applications and Uses

The present disclosure also provides use of the composite as a cushion material or a seat padding material.

The composite can be adapted for a variety of uses. Examples include, but are not limited to, use of the composite with chairs, stools, home furniture, beds, sofas, mattress, pillows, automobiles, motorcycles, trains, airplanes, boats, ships, seacraft, aircraft, spacecraft, tractors, bicycles, unicycles, tricycles, recreational vehicles, dune buggies, jet skis, stadium seats, spacecraft, hovercraft, ski lifts, roller coaster, glider, luge, bobsled, recliners, gurneys, beds, yoga mats, pet crate liners, gardening knee mats, or any other kind of cycle, vehicle, seat, or furniture. In some embodiments, the composite is used in the seats of automobiles, motorcycles, trains, airplanes, boats, seacraft, aircraft, spacecraft and so on. In some embodiments, the composite is used in chairs, stools, home furniture, beds, sofas, mattress, and so on.

In some embodiments, the composite can be covered with an outerwrap.

The present disclosure further provides a product comprising the composite disclosed herein.

In some embodiments, the product can be a cushion, for example, a vehicle cushion. In some embodiments, the product can be selected from the seats of automobiles, motorcycles, trains, airplanes, boats, seacraft, aircraft, spacecraft and the like. In some embodiments, the product can be chairs, stools, home furniture, beds, sofas, mattress, and the like.

It is to be understood that both the foregoing general description and the following detailed description are exemplary and explanatory only and are not restrictive of the invention, as claimed.

### Examples

Some embodiments of the invention will now be described in the following Examples, wherein all parts and percentages are by weight unless otherwise specified.

The three-dimensional randomly bonded fiber loops cushions were prepared at Zhangjiagang City Dida Machinery Co., Ltd using the raw materials provided by Dow. Information of raw materials used in the examples is listed in Table 1.

TABLE 1
Basic information of raw materials used to make 3DL cushions

| | PRODUCER | DENSITY* | MI** | COMONOMER |
|---|---|---|---|---|
| ELITE ™ 5815 | THE DOW CHEMICAL | 0.910 | 15 | Ethylene/Octene |
| | COMPANY | | | |
| ELITE ™ 5220G | THE DOW CHEMICAL | 0.915 | 3.5 | Ethylene/Octene |
| | COMPANY | | | |
| ENGAGE ™ 8003 | THE DOW CHEMICAL | 0.885 | 1 | Ethylene/Octene |
| | COMPANY | | | |
| ENGAGE ™ 8401 | THE DOW CHEMICAL | 0.885 | 30 | Ethylene/Octene |
| | COMPANY | | | |
| PO-1 | THE DOW CHEMICAL | 0.905 | 15 | Ethylene/Octene |
| | COMPANY | | | |
| INFUSE ™ 9530 | THE DOW CHEMICAL | 0.887 | 5 | Ethylene/Octene |
| | COMPANY | | | |
| COSMOTHENE ® G812 | TPC | 0.917 | 35 | Not disclosed |

*unit: g/cc;
**unit: g/10 min; 190° C. 2.16 kg

The material formulations of 3DL cushions used in this invention are listed in Table 2, the blended resin density was from 0.885 to 0.916 g/cc. Usually, the higher density of polyolefin means the higher crystallinity of polymer, then the material is stiffer but rebound is reduced. INFUSE™ 9530 is an olefin block copolymer (OBC), and compared to POE (olefin random copolymers), OBC shows higher heat resistance and good resilience.

TABLE 2
Basic information of material formulations
used in 3DL cushions (%)

| | 3DL-1 | 3DL-2 | 3DL-3 | 3DL-4 | 3DL-5 |
|---|---|---|---|---|---|
| ENGAGE ™ 8003 | 25 | | | | |
| ENGAGE ™ 8401 | 75 | | | | |
| INFUSE ™ 9530 | | 100 | | | |
| PO-1 | | | 100 | | |
| ELITE ™ 5815 | | | | 100 | |
| ELITE ™ 5220G | | | | | 50 |
| COSMOTHENE ® | | | | | 50 |
| G812 | | | | | |
| RESIN DENSITY | 0.885 | 0.887 | 0.905 | 0.910 | 0.916 |

The chemicals used to make PU foams are listed in Table 3.

TABLE 3
Basic information of raw materials used to make PU foams

| | PRODUCER | FEAUTRE | WT.-% |
|---|---|---|---|
| VORANOL ™ CP 6001 | THE DOW CHEMICAL | EO/PO polyol, f = 3; OHv = 29, primary | 85.7 |
| | COMPANY | OH about 80%, EO content = 15% | |
| SPECFLEX ™ NC 702 | THE DOW CHEMICAL | Styrene and acrylonitrile copolymer | 10.0 |
| | COMPANY | polyol, OHv = 22, solid content = 40% | |
| TEGOSTAB B8734 LF2 | EVONIK | Silicone surfactant | 0.5 |
| DIETHANOLAMINE | THE DOW CHEMICAL | Cross linker | 0.5 |
| | COMPANY | | |
| NIAX A-1 | MOMENTIVE | Catalyst | 0.1 |
| DABCO 33LV | EVONIK | Catalyst | 0.4 |
| WATER | | Blowing agent | 2.8 |
| SPECFLEX ™ NE 496 | THE DOW CHEMICAL | Isocyanate, NCO = 31% | 50.0 |
| | COMPANY | | |

3D Loop manufacturing:

The polymer resin pellets (dry blended if more than one resin was used) were fed in the single screw extruder and melt was then extruded though the T-die with 80×5 nozzles. The fiber diameter was around 0.8 mm, and the extruder and die temperature was set at 200° C., (for sample 3DL-2 it was set at 235° C.), fiber melt dropped to cold water (25° C.) and fiber curling and bonding with each other and cooled to form 3D loop samples. The 3DL cushion sample thickness was controlled at 30 mm, and each formulation was prepared for three densities (30/40/50 kg/m³) for different supporting effect in PU foam. Samples were stabilized at room temperature for 24 hours and then cut into 400×400×30 mm for further use.

Preparation of PU foam/3DL composite:

Isocyanate reactive compounds (polyol, water, catalyst, silicone surfactants etc.) and isocyanate are weighed into 1 liter cup and mixed by high-speed mixer, then the mixture was placed into a mold (400 mm×400 mm×50 mm) at temperatures ranging from 50° C. to 70° C. Mold was closed after pouring of the reactive mixture on the bottom of the mold itself (CE1) or on the surface of the 3DL preform if the 3DL preform was applied (IE). De-molding times varied depending on the selected catalyst and catalyst concentrations; however, all the inventive examples (IE) and the comparative examples (CE) were de-molded after 300 seconds from casting.

TABLE 4
Comparative sample information

| | CE1 | CE2 | CE3 | CE4 |
|---|---|---|---|---|
| Material | PU foam | POE 3DL | LLDPE 3DL | TPEE 3DL |
| Thickness (mm) | 50 | 50 | 50 | 50 |
| Density (kg/m³) | 80 | 68 | 70 | 78 |

Four commercially available cushion materials were used as comparative examples, as shown in Table 4. They were all uniform single layer structure, either made of PU foam or 3DL (not a composite). In the inventive examples, the 3DLs made of different materials and densities were embedded in the bottom of the PU foam, as shown in FIG. 2. The sample information is listed in Table 5.

TABLE 5
Inventive sample information

| | IE1 | IE2 | IE3 | IE4 | IE5 | IE6 |
|---|---|---|---|---|---|---|
| Composite | 50 | 50 | 50 | 50 | 50 | 50 |
| thickness (mm) | | | | | | |
| 3DL | 30 | 30 | 30 | 30 | 30 | 30 |
| thickness (mm) | | | | | | |
| 3DL position | bottom | bottom | bottom | bottom | bottom | bottom |
| 3DL material | 3DL-1 | 3DL-1 | 3DL-1 | 3DL-2 | 3DL-2 | 3DL-2 |
| composition | | | | | | |
| 3DL | 30 | 40 | 50 | 30 | 40 | 50 |
| density (kg/m³) | | | | | | |
| | IE7 | IE8 | IE9 | IE10 | IE11 | IE12 |
| Composite | 50 | 50 | 50 | 50 | 50 | 50 |
| thickness (mm) | | | | | | |
| 3DL | 30 | 30 | 30 | 30 | 30 | 30 |
| thickness (mm) | | | | | | |
| 3DL position | bottom | bottom | bottom | bottom | bottom | bottom |
| 3DL material | 3DL-3 | 3DL-3 | 3DL-3 | 3DL-4 | 3DL-4 | 3DL-4 |
| composition | | | | | | |
| 3DL | 30 | 40 | 50 | 30 | 40 | 50 |
| density (kg/m³) | | | | | | |

| | IE13 | IE14 | IE15 |
|---|---|---|---|
| Composite | 50 | 50 | 50 |
| thickness (mm) | | | |
| 3DL | 30 | 30 | 30 |
| thickness (mm) | | | |
| 3DL position | bottom | bottom | bottom |
| 3DL material | 3DL-5 | 3DL-5 | 3DL-5 |
| composition | | | |
| 3DL | 30 | 40 | 50 |
| density (kg/m³) | | | |

### Tested Properties and Results

TABLE 6
Mechanical properties of cushion samples used in this invention

| | | CE1 | CE2 | CE3 | CE4 | IE1 | IE2 | IE3 |
|---|---|---|---|---|---|---|---|---|
| Density (kg/m³) | | 80 | 68 | 70 | 78 | 111 | 117 | 122 |
| 65% IFD (N) | | 1200 | 1230 | 1020 | 540 | 1950 | 2100 | 2050 |
| 25% IFD (N) | | 465 | 403 | 301 | 170 | 577 | 575 | 485 |
| SAG factor | ≥3.2 | 2.6 | 3.1 | 3.4 | 3.2 | 3.4 | 3.7 | 4.2 |
| Rebound (%) | ≥40 | 62 | 61 | 35 | 80 | 50 | 49 | 46 |
| Hysteresis loss (%) | ≤40 | 26 | 33 | 54 | 16 | 32 | 33 | 34 |
| Compression | ≤20 | 3 | 47 | 34 | 23 | 7 | 8 | 8 |
| Residual Strain (%) | | | | | | | | |
| Thickness change | ≤5 | 0.1 | 5.6 | 8.6 | 3.2 | 0.6 | 0 | 0.7 |
| after fatigue (%) | | | | | | | | |
| Firmness change | ≤25 | 3 | 44 | 40 | 32 | 11 | 12 | 8 |
| after fatigue (%) | | | | | | | | |

| | | IE4 | IE5 | IE6 | IE7 | IE8 | IE9 |
|---|---|---|---|---|---|---|---|
| Density (kg/m³) | | 110 | 116 | 122 | 113 | 117 | 121 |
| 65% IFD (N) | | 1820 | 2050 | 2350 | 2100 | 2400 | 2650 |
| 25% IFD (N) | | 570 | 630 | 610 | 610 | 650 | 635 |
| SAG factor | ≥3.2 | 3.2 | 3.3 | 3.9 | 3.4 | 3.7 | 4.2 |
| Rebound (%) | ≥40 | 49 | 44 | 43 | 44 | 44 | 51 |
| Hysteresis loss (%) | ≤40 | 33 | 34 | 37 | 31 | 33 | 33 |
| Compression | ≤20 | 5 | 6 | 5 | 4 | 7 | 8 |
| Residual Strain (%) | | | | | | | |
| Thickness change | ≤5 | 0.5 | 0 | 0.1 | 0.4 | 0 | 0.5 |
| after fatigue (%) | | | | | | | |
| Firmness change | ≤25 | 10 | 14 | 14 | 11 | 12 | 15 |
| after fatigue (%) | | | | | | | |
| | | IE10 | IE11 | IE12 | IE13 | IE14 | IE15 |
| Density (kg/m³) | | 112 | 118 | 123 | 109 | 118 | 124 |
| 65% IFD (N) | | 1970 | 2410 | 2670 | 2040 | 2400 | 2800 |
| 25% IFD (N) | | 615 | 630 | 615 | 600 | 610 | 608 |
| SAG factor | ≥3.2 | 3.2 | 3.8 | 4.3 | 3.4 | 3.9 | 4.6 |
| Rebound (%) | ≥40 | 48 | 43 | 44 | 45 | 45 | 48 |
| Hysteresis loss (%) | ≤40 | 33 | 35 | 35 | 34 | 37 | 38 |
| Compression | ≤20 | 6 | 7 | 7 | 6 | 7 | 9 |
| Residual Strain (%) | | | | | | | |
| Thickness change | ≤5 | 0.8 | 0.4 | 0.5 | 0.4 | 0.9 | 0.5 |
| after fatigue (%) | | | | | | | |
| Firmness change | ≤25 | 16 | 13 | 13 | 12 | 15 | 13 |
| after fatigue (%) | | | | | | | |

The properties of cushion samples are shown in Table 6. For CE1 (PU foam), the SAG factor was only 2.6, far below the target (≥3.2). Samples CE2-CE4 failed in the Compression Residual Strain (heat resistance) and durability tests (either on thickness change, or firmness change after fatigue).

All the inventive samples showed an SAG factor ≥3.2, with very good Compression Residual Strain and durability properties. The composite samples showed rebound >40% and hysteresis loss <40%, suggesting good comfort feature for cushion pads.

25% IFD of the samples was in a range of 550 to 650 N and didn't increase much when higher density 3DL was used in the composite. This should attribute to the asymmetric structure of the composite foam. Although firmness of the bottom of the composite was increased by using high density 3DL, the top layer was still pure PU foam, and as a result, surface firmness was not much impacted, but overall firmness of the composite was improved a lot. This is the reason why such composite can reduce the total thickness of seat cushion, without changing much on the soft surface and keeping enough firmness to support the body weight.

Such a composite cushion with extremely high SAG factor can be used in a thinner seat design to save space but keep comfort feature for passengers.

### Measurements

### Density of the Composite

The mass and the dimensions of the specimen were determined, and the volume (in kilograms per cubic meter) was calculated:

$$Density = M / V$$

$$where : M = mass of specimen , kg , and V = volume of specimen , {m}^{3} .$$

### Resilience (Rebound) of the Composite

Resilience was conducted following standard ASTM D3574-2017. The ball rebound tester shall consist of a 40±4 mm inside diameter vertical clear plastic (such as acrylic) tube, into which a 16.0±0.2 mm diameter steel ball, weighing 16.3±0.2 g, is released by a magnet or other device. The height of drop shall be 500 mm. Center the specimen at the base of the tube and adjust the height of the tube so that zero rebound is 16.0±0.2 mm above the surface of the foam specimen. Mount the steel ball on the release mechanism, then drop it and note the maximum rebound height (top of ball). If the ball strikes the tube on the drop or rebound, the value obtained is invalid. This condition is usually due to the tube not being vertical or irregularities on the specimen surface. In order to minimize parallax error, the circles on the tube in the region where the percent rebound is read must appear as lines. Make an additional two drops on the same specimen in the same location, noting the maximum rebound height, Calculate the mean of the three rebound values.

### Hysteresis Loss Test

Hysteresis Loss is defined as the difference between the loading energy and the unloading energy, expressed as a percentage of the loading energy. It was tested following ASTM D3574-2017. This measures the loss of ability of flexible foam to return to its original support characteristics after compression. Bring the indenter foot into contact with the specimen at a rate of 50±5 mm/min, while applying a contact force of 4.5±0.5 N to determine the specimen's initial thickness. Immediately indent the specimen 75% of its initial thickness at a rate of 50±5 mm/min. Immediately remove the compression force at 50±5 mm/min until the platen fully returns. Calculate the hysteresis loss as defined below.

Hysteresis Loss=(Loading Energy−Unloading Energy)/Loading Energy×100%
where: Energy is defined as the area under the force/deflection curve. Loading Energy is the energy required to indent or compress a flexible specimen to a preset deflection (compression cycle). Unloading Energy is the energy recovered when the indentation or compression platen is retracted from the preset deflection and completely unloaded. (Decompression cycle).

### Indentation Force Deflection (IFD) and SAG Factor

Indentation Force Deflection (IFD) tests measure firmness of foam cushions, following the standard ASTM D3574-2017. High IFD test results imply increased hardness. Low IFD results indicate soft foam products. the indentation force deflection procedure measures the force required to indent a 20 cm diameter steel plate into a foam sample to a stated percentage of the test sample's initial height which is commonly 5 cm. Common IFD values are generated at 25 and 65 percent of initial height. One of the measured outcomes of an IFD Test is termed Comfort Support Factor (SAG factor), which is the ratio of indentation force deflection measurements 65% IFD/25% IFD. Support factor is an important indicator of the point at which foam cushions bottom out. Low support factors are more likely to hit bottom.

### Compression Residual Strain

The compression residual strain reflects the heat resistance of cushion products. The specimens were cut into 20 cm by 20 cm square shape, with uniform thickness around 5 cm. After compressed for 50% compression using a compression fixture with 22 hours at 70° C., the compression was removed, and 3D loop samples were allowed to recover for 30 min at room temperature. The final specimen thickness was measured, and the compression set was calculated using the following equation.

$$Compression residual strain ( \% ) = [ ( {T}_{o} - {T}_{f} ) / {T}_{o} ] \times 100 where$$

$${T}_{o} is the original sample thickness , {T}_{f} is the final sample thickness .$$

### Durability (Fatigue) Test Condition

Durability of 3D loop samples were measured in MTS 810 following with ASTM D 3574-2017, Indentation Force Deflection (IFD) is used to character the hardness of cushion materials. The impact load was set at 750±20 N (mimic an adult's weight) and push head was a 20 cm round disk with round edge (similar to hip contact area), and 80,000 impact cycles to mimic 7 years daily use. The sample was put on the test platform and the PU foam side contacts the push head. After the fatigue, sample was placed under unstressed condition for 10±0.5 minutes, then character the final firmness and thickness, and calculate the thickness change and IFD change.

What is claimed is:

1. A composite comprising,
a polyurethane foam, and
a three-dimensional loop (3DL) preform comprising a plurality of randomly bonded thermoplastic fiber loops,
wherein the 3DL preform is asymmetrically embedded in the polyurethane foam, with the voids of the fiber loops partially or completely filled with the polyurethane foam, and
wherein the composite has an SAG factor of no less than 3.2, wherein the SAG factor is defined as the ratio of 65% Indentation Force Deflection (IFD) to 25% IFD.

2. The composite according to claim 1, wherein the thickness of the polyurethane foam is larger than the 3DL preform.

3. The composite according to claim 1, wherein greater than 50% of the fiber loops comprised in the 3DL preform are made of a polyolefin, preferably a polyolefin elastomer.

4. The composite according to claim 3, wherein the polyolefin has a melting index (MI) of 1 to 35 g/10 min @190° C., 2.16 kg.

5. The composite according to claim 3, wherein the polyolefin has a density of 0.88 to 0.92 g/cm³.

6. The composite according to claim 1, wherein the polyurethane foam is a reaction product of a reaction mixture comprising (i) a polyol component comprising one or more polyols selected from the group consisting of a polyester polyol, a polyether polyol, and the combination thereof, and (ii) an isocyanate component comprising one or more isocyanate compounds.

7. The composite according to claim 6, wherein the reaction mixture further comprises one or more components selected from the group consisting of: catalysts, blowing agents, foam-stabilizing surfactants, chain extension and or cross linkage agents, and combinations thereof.

8. The composite according to claim 1, wherein the polyurethane foam has a density of from 15 to 150 kg/m³.

9. The composite according to claim 1, wherein the compression residual strain of the composite measured in accordance with ASTM D 3574-2017 (D) is <20%.

10. The composite according to claim 1, wherein the thickness change after fatigue of the composite measured in accordance with ASTM D 3574-2017 (13) is <5%.

11. The composite according to claim 1, wherein the firmness change after fatigue of the composite measured in accordance with ASTM D 3574-2017 (13) is <25%.

12. The composite according to claim 1, wherein the composite comprises a pure polyurethane foam portion extending from the intended force-bearing surface of the composite to a depth that is at least 10% of the total thickness of the composite.

13. A method of preparing the composite according to claim 1, comprising,
disposing, in a mold, a 3DL preform comprising a plurality of randomly bonded thermoplastic fiber loops;
injecting a reaction mixture into the mold and foaming in-situ, so that the 3DL preform is asymmetrically embedded in the polyurethane foam with the voids of the fiber loops partially or completely filled with the polyurethane foam;
solidifying the foam; and
releasing the composite from the mold.

14. A product comprising the composite according to claim 1.
